(19) United States
(12) Patent Application Publication
(10) Pub. No.: US 2013/0018816 A1
(43) Pub. Date: Jan. 17, 2013

(54) INDEX FOR A PORTFOLIO AND RELATED METHOD AND APPARATUS

(71) Applicants: Sandy Campbell RATTRAY, London (GB); Khalil MOHAMMED, London (GB); Gediminas STANZYS, London (GB); Samuel Benjamin Philip RADNOR, London (GB)

(72) Inventors: Sandy Campbell RATTRAY, London (GB); Khalil MOHAMMED, London (GB); Gediminas STANZYS, London (GB); Samuel Benjamin Philip RADNOR, London (GB)

(73) Assignee: GLG PARTNERS LP, London (GB)

(21) Appl. No.: 13/179,776

(22) Filed: Jul. 11, 2011

(51) Int. Cl. G06Q 40/00

(52) U.S. Cl. 705/36 R

(57) ABSTRACT

The present invention relates to an index for a portfolio, wherein the index value of the portfolio is determined in dependence on the value of the assets comprising the portfolio. The assets comprising the portfolio include cash. The invention also relates to a method of characterising a portfolio, and correctly managing transaction costs. Said method determines an index value of the portfolio in dependence on the value of the assets comprising the portfolio, wherein the value of the assets comprising the portfolio is divided by a constant number. The invention further relates to an apparatus for calculating an index for a portfolio.

### FIELD OF THE INVENTION

The present invention relates to an index for a portfolio, a method of generating an index for a portfolio, an apparatus for generating an index for a portfolio, and a non-transitory computer-readable medium encoding a data structure for generating an index for a portfolio. In particular the invention relates to an index for an actively managed portfolio. More particularly the invention relates to an index for use as an underlier to an Exchange Traded Fund and index derivatives.

### BACKGROUND OF THE INVENTION

A variety of formats are used in the financial industry to combine investment assets. Mutual funds for example have a professional managing a pool of investments to combine a favourable selection of assets according to the fund's investment objective. Exchange-traded funds (ETFs) similarly have a professional managing a pool of investments to combine a selection of assets, but in addition shares of the ETF are traded throughout the day, much like stocks. To allow this trading activity, the fund must be highly transparent. A typical way of achieving transparency is to base the fund on a stock market index (passive index ETF). In this case the fund is compositionally related to the index. Actively managed ETFs however face problems maintaining a suitable level of transparency. There is therefore a need to characterise an actively managed portfolio, such that an actively managed ETF can maintain full transparency, as described by this invention.

In U.S. Pat. No. 7,792,719 a method of constructing an index of assets is disclosed. The assets selected in the index are weighted based on metrics other than market capitalization, equal weighting, or share price weighting. Exemplary metrics include: book value, sales, revenue, earnings, earnings per share, income, income growth rate, dividends, dividends per share, earnings before interest, tax, depreciation and amortization.

### SUMMARY OF INVENTION

In broad terms, the index value of a portfolio is determined in dependence on the value of the assets comprising the portfolio. In particular, the portfolio assets include cash. The index value of a portfolio is calculated by dividing the value of the assets comprising the portfolio by a (preferably predetermined) constant number. The index is suitable as an underlier to an exchange traded fund or a derivative instrument.

According to an aspect of the present invention there is provided a method of generating an index for a portfolio, comprising determining the index value of the portfolio in dependence on the value of the assets comprising the portfolio, wherein said assets include cash.

By providing a cash component the portfolio may be actively managed; that is to say the assets held within the portfolio can change from day to day without triggering excessive turnover. The index of the actively managed portfolio (the ‘active portfolio index’) is intended to be hedgeable by broker-dealers who would like to make markets in an exchange traded fund on the index or in derivative contracts on the index. Preferably, the portfolio, and its composition (and the index), is actively managed. Preferably, the selection of the asset types follows a strategy. Typically, the portfolio includes a plurality of components, and advantageously said assets include a stock component.

Preferably, the index is suitable for use as an underlier to at least one of: a fund; a stock market fund; a traded fund; an exchange traded fund; an active exchange traded fund; and a derivative instrument.

Preferably, assets being added to the portfolio are balanced (in the index) by subtracting the associated purchase value from the cash. Preferably, assets being released from the portfolio are balanced (in the index) by adding the associated sale value to the cash.

Preferably, a transaction fee is subtracted from the cash for at least one of: purchase of assets; and sale of assets. This encourages the provision of transaction services, for example from brokers, including execution services and research services. These factors benefit the efficient management of the fund. Preferably, the transactions (for example one or more of: the addition of assets and the subtraction of the purchase value; and the release of assets and the addition of the sale value) are placed shortly before the scheduled time for periodic rebalancing. This takes into account the reality of having to execute transactions before the rebalancing in preparation for changes to the next period's portfolio. Preferably transactions are placed at (or near) the close of business, preferably at a closing auction, and rebalancing occurs (preferably shortly) after close of business (by “close of business” is preferably meant the time at which trading ceases, or the time period between cease of continuous trading and cease of all trading activities). For example for daily rebalancing after close of business, the transactions preferably occur an hour, half an hour, ten minutes, five minutes, one minute, or more, or less before close of business; and the accounting for the transactions preferably occurs an hour, half an hour, ten minutes, five minutes, one minute, ten seconds, or more, or less after close of business. Preferably, the transaction fee is subtracted from the cash at the same time as when the transactions are placed. Preferably transaction fee(s) are subtracted from the cash (preferably shortly) before rebalancing. This takes into account the reality of having to commit cash for the transaction at the time when the transaction is executed, that is, shortly before rebalancing, for rebalancing that results in changes to the portfolio in the next period. For example for daily rebalancing after close of business, transaction fee(s) are accounted for preferably an hour, half an hour, ten minutes, five minutes, one minute, or more, or less before close of business. Alternatively, the transaction fee may be subtracted from the cash at the close of business. Alternatively, the transaction fee is subtracted from the cash when the portfolio is rebalanced.

Preferably, proceeds from said assets are added to the cash. Preferably, the proceeds are at least one of: dividends; bonuses; coupon payments; and interest. Proceeds for a period may be accounted for after the scheduled time for that period's rebalancing. For example for daily rebalancing at close of business, the proceeds of one business period may be accounted for after close of business of that period, preferably before open of business of the next period.

Preferably, the method further comprises rebalancing the portfolio. This can allow the composition to be changed according to the strategy underlying the active management. Preferably the composition of assets in the portfolio is changed after said rebalancing. The advantage is a portfolio (and index) that is managed for better performance. Preferably, the portfolio (and the index) is periodically rebalanced. Preferably, rebalancing occurs at a scheduled time. Preferably, rebalancing occurs relatively often, for example once monthly, once weekly, once daily (preferably where the day is a business day), twice daily (preferably where the day is a business day), three times daily (preferably where the day is a business day), hourly (preferably where the day is a business day and preferably during hours of business), or more or less frequently. More preferably, the portfolio (and the index) is rebalanced once daily (preferably where the day is a business day) substantially at the close of business. Alternatively, the rebalancing may occur at another time, for example at midday, at open of business, or any other time. Relatively frequent rebalancing can enable active management of the portfolio (and index). As a result, the active portfolio index can have a high turnover, in particular relative to a conventional index.

Preferably, the portfolio is rebalanced at substantially the same time as (preferably shortly after) said index value of the portfolio is determined. In this manner the rebalancing need not distort the index value. Preferably, the index value of the portfolio at a given period is dependent upon the current value of a stock component of the portfolio and cash expended in changing the composition of the portfolio for the preceding rebalancing. This can allow the index to be more accurate than otherwise. Preferably, said index value of the portfolio is dependent upon a fee, said fee being associated with a change in the composition of assets to be made at the next rebalancing. This can allow the index to be more accurate than otherwise. Preferably, the index value of the portfolio at a given period is dependent upon at least one of: the current value of a stock component of the portfolio; the cash expended in changing the composition of the portfolio for the preceding rebalancing; the proceeds from corporate actions incurred during the period before the preceding rebalancing; the cash in the portfolio immediately before the preceding rebalancing; and the transaction fees incurred for the next (preferably planned) rebalancing.

Preferably, said portfolio rebalancing comprises:
a) receiving instructions to change said portfolio;
b) verifying that the changes to said portfolio are permitted; and
c) transmitting said instructions.

Preferably, said index value of the portfolio is determined periodically. Preferably, said index value of the portfolio is determined at substantially the same time as (preferably shortly before) rebalancing. Preferably, said index value is determined regularly. Said index value may be determined at close of business. Preferably, said index value of the portfolio is determined at a scheduled time. Preferably, said index value of the portfolio is determined relatively often, for example once monthly, once weekly, once daily (preferably where the day is a business day), twice daily (preferably where the day is a business day), three times daily (preferably where the day is a business day), hourly (preferably where the day is a business day and preferably during hours of business), or more or less frequently; the index value may for example be determined more frequently than hourly and less frequently than weekly. Particularly preferably, said index value of the portfolio is determined once daily (preferably where the day is a business day) preferably at the close of business. Alternatively, said index value of the portfolio may be determined at another time, for example at midday, at open of business, or any other time, preferably within the business period. Alternatively, the said index value of the portfolio may be determined more often than rebalancing occurs.

Preferably, a composition of the portfolio does not change in the period from open of business to close of business.

Preferably, the value of the assets is the market value of the assets. Preferably, values in a different currency than the portfolio currency are converted into the portfolio currency with an exchange rate. Preferably, the value of an asset is calculated by multiplying the current trade price of one share in the asset by the number of shares of the asset in the portfolio.

Preferably, the cash comprises between 0.5% and 15% of the portfolio value. More preferably, the cash comprises between 3% and 5% of the portfolio value.

Preferably, the asset holdings are adjusted to produce a positive cash balance after a predefined period of time has elapsed with a negative cash balance

Preferably, the value of each asset type in the portfolio is limited to a predetermined maximum percentage of the portfolio value. Preferably, the maximum percentage of the portfolio value depends on the number of asset types in the portfolio. For example, the value of each asset type is limited to 20% of the portfolio value when there are less than 25 asset types; the value of each asset type is limited to 15% of the portfolio value when there are between 25 and 39 asset types; and the value of each asset type is limited to 10% of the portfolio value when there are more than 40 asset types. These provisions allow compliance with typical regulatory requirements on diversification.

Preferably, the index is calculated by dividing the value of the assets comprising the portfolio by a predetermined constant number.

In another aspect, there is provided a method of calculating an index for a portfolio; a method of determining an index for a portfolio; a method of constructing an index for a portfolio; and a method of characterising a portfolio, comprising generating an index.

According to a yet further aspect of the present invention there is provided a method for generating an index of assets, comprising determining the value of the assets, wherein said assets include cash.

According to a yet further aspect of the present invention there is provided a method of generating an index of assets, the method implemented by at least one analysis host processor, the at least one analysis host processor comprising at least one computer processor, the method comprising:

(a) accessing by the at least one analysis host processor of one or more databases storing and permitting retrieval of data about a plurality of assets;
(b) retrieving by the at least one analysis host processor one or more of said data about said plurality of said assets; and
(c) calculating by the at least one analysis host processor the index of assets to be objective measure;
wherein said assets include cash.

Preferably said calculating comprises: calculating the value of said plurality of said assets; and dividing the value of said plurality of said assets by a constant number.

Preferably, said calculating of the market value of said plurality of said assets comprises: subtracting a purchase value from the cash for assets being added; adding a sale value to the cash for assets being released; subtracting a transaction fee from the cash for at least one of: purchase of assets; and sale of assets; and adding proceeds from said assets to the cash.

According to a further aspect of the present invention there is provided a method of generating an index for a portfolio, comprising determining the index value of the portfolio in dependence on the value of the assets comprising the portfolio, wherein the value of the assets comprising the portfolio is divided by a predetermined constant number.

By dividing the value of the assets comprising the portfolio by a constant number the resulting index value may be more readily representative of the value of the portfolio.

Preferably, the assets include cash. By providing a cash component the portfolio may be actively managed; that is to say the assets held within the portfolio can change from day to day without triggering excessive turnover.

According to a yet further aspect of the present invention there is provided apparatus for generating an index for a portfolio, comprising: a processor adapted to determine the index value of the portfolio in dependence on the value of the assets comprising the portfolio, wherein said assets include cash, and an output adapted to output the index value.

Preferably, the index is suitable for use as an underlier to at least one of: a fund; a stock market fund; an exchange traded fund; an active exchange traded fund; and a derivative instrument.

Preferably, the processor is adapted to divide the value of the assets comprising the portfolio by a predetermined constant number.

Preferably, the apparatus further comprises an input, and the processor is further adapted to receive data from the input. Preferably, the apparatus further comprises a database, and the processor is further adapted to receive data from the database. Preferably, the processor is further adapted to calculate the value of the assets comprising the portfolio in dependence on the data.

There is also provided according to the invention: apparatus for calculating an index for a portfolio; apparatus for determining an index for a portfolio; apparatus for constructing an index for a portfolio (wherein in each case the processor is adapted to generate an index); and apparatus for characterising a portfolio by generating an index.

According to a yet further aspect of the present invention there is provided apparatus for generating an index for portfolio, comprising: a processor adapted to determine the index value of the portfolio in dependence on the value of the assets comprising the portfolio, wherein the value of the assets comprising the portfolio is divided by a predetermined constant number; and an output adapted to output the index value.

According to a yet further aspect of the present invention there is provided an apparatus for generating an index for a portfolio, comprising: means for determining the index value of the portfolio in dependence on the value of the assets comprising the portfolio, wherein said assets include cash, and means for outputting said index value

According to a yet further aspect of the present invention there is provided apparatus for generating an index for a portfolio, comprising: means for determining the index value of the portfolio in dependence on the value of the assets comprising the portfolio, wherein the value of the assets comprising the portfolio is divided by a predetermined constant number; and means for outputting said index value.

According to a yet further aspect of the present invention there is provided a non-transitory computer-readable medium encoding a data structure for generating an index for a portfolio, said data structure being adapted to determine the index value of the portfolio in dependence on the value of the assets comprising the portfolio, wherein said assets include cash.

Preferably, the index is suitable for use as an underlier to at least one of: a fund; a stock market fund; an exchange traded fund; an active exchange traded fund; and a derivative instrument.

Preferably, the index is determined by using said data structure to access the stored value of the assets comprising the portfolio and by dividing the value by a predetermined constant number.

According to a yet further aspect of the present invention there is provided a non-transitory computer-readable medium encoding a data structure for generating an index for a portfolio, said data structure being adapted to determine the index value of the portfolio in dependence on the value of the assets comprising the portfolio, wherein the value of the assets comprising the portfolio is divided by a predetermined constant number.

Preferably, said assets include cash.

According to a yet further aspect of the present invention there is provided an index for a portfolio, wherein the index value of the portfolio is determined in dependence on the value of the assets comprising the portfolio, and wherein said assets include cash.

According to a yet further aspect of the present invention there is provided an index for a portfolio, wherein the index value of the portfolio is determined in dependence on the value of the assets comprising the portfolio, and, wherein the value of the assets comprising the portfolio is divided by a predetermined constant number.

According to a yet further aspect of the present invention there is provided a system for generating an index for a portfolio, comprising: a processor adapted to determine the value of the assets comprising the portfolio, wherein said assets include cash, and wherein said processor is further adapted to determine the index value of the portfolio in dependence on the value of the assets comprising the portfolio; and an output adapted to output the index value.

Preferably, the system is further adapted to receive data from at least one of: input; and a database. More preferably, the system is further adapted to determine the value of the assets comprising the portfolio in dependence of the data.

According to a yet further aspect of the present invention there is provided a system for generating an index for a portfolio, comprising: a processor adapted to determine the value of the assets comprising the portfolio, wherein said processor is further adapted to determine the index value of the portfolio by dividing the value of the assets comprising the portfolio by a predetermined constant number, and an output adapted to output the index value.

According to a yet further aspect of the present invention there is provided an active exchange traded fund. An active exchange traded fund connotes a fund whose assets can change from day to day with relatively high turnover compared to a passive market index, and yet be traded on an exchange.

According to a yet further aspect of the present invention there is provided an active portfolio index for use as an underlier to an exchange traded fund. An active portfolio index connotes an index of an actively managed portfolio of assets.

According to a yet further aspect of the present invention there is provided an index for an actively managed portfolio suitable for use as an underlier to an exchange traded fund.

According to a yet further aspect of the present invention there is provided a method of generating an Active Portfolio Index for use as underlier to exchange traded funds and derivative instruments, comprising determining an index value of the fund in dependence on the value of the assets comprising the fund, wherein said assets include cash.

Further features of the invention are characterised by the dependent claims.

The invention extends to methods and/or apparatus substantially as herein described with reference to the accompanying drawings.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention also provides a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

Any apparatus feature as described herein may also be provided as a method feature, and vice versa. As used herein, means plus function features may be expressed alternatively in terms of their corresponding structure, such as a suitably programmed processor and associated memory.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

Furthermore, features implemented in hardware may generally be implemented in software, and vice versa. Any reference to software and hardware features herein should be construed accordingly.

These and other aspects of the present invention will become apparent from the following exemplary embodiments that are described with reference to the following figures in which:

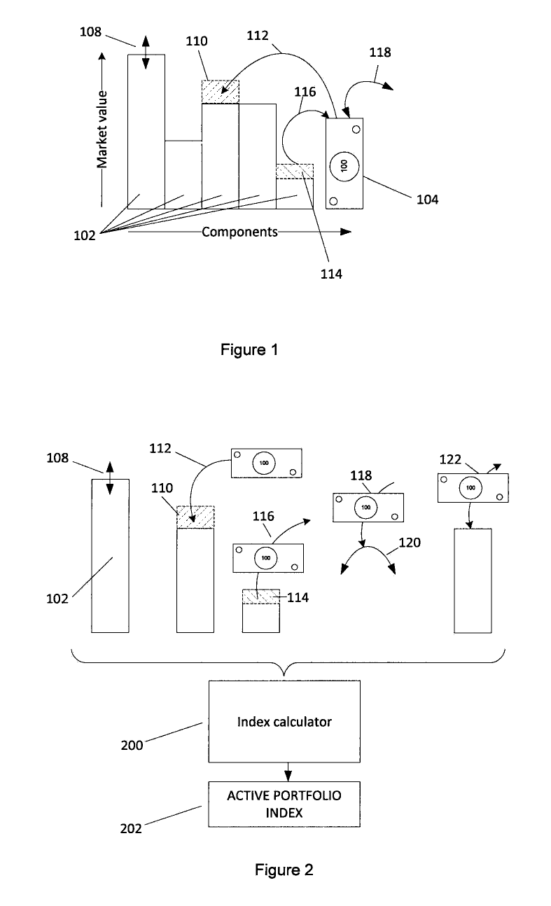

FIG. 1 shows the composition of the Active Portfolio Index;

FIG. 2 shows contributions from different portfolio components to the Active Portfolio Index;

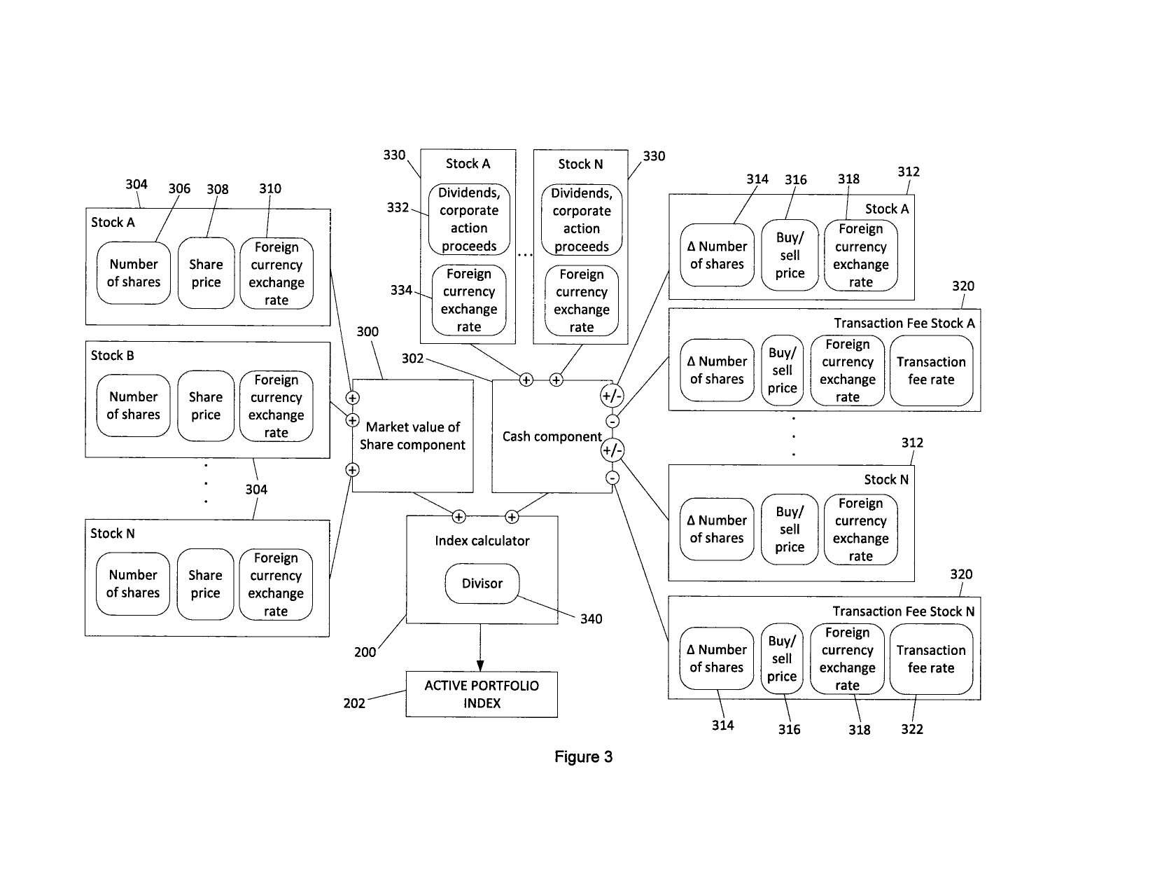

FIG. 3 shows calculation of the Active Portfolio Index;

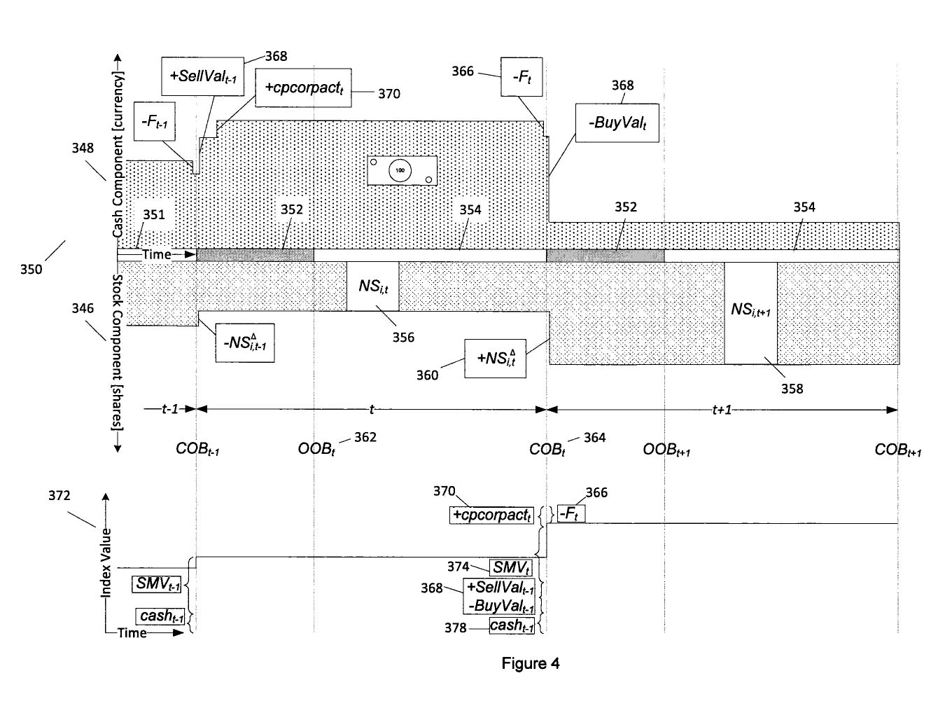

FIG. 4 shows an example of timing and contribution of different factors;

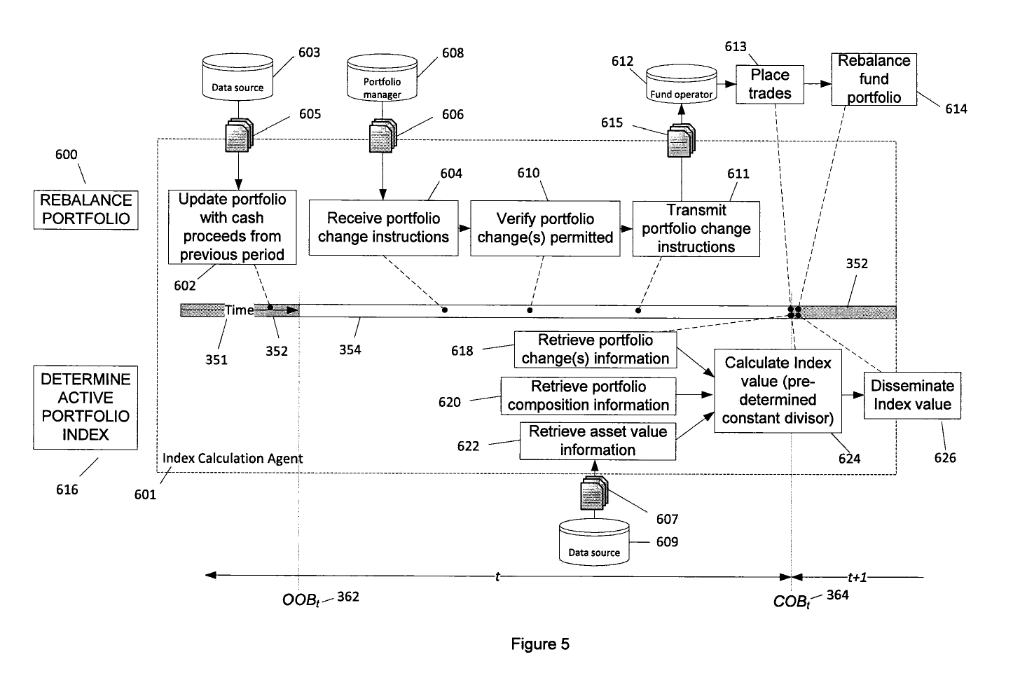

FIG. 5 shows an example of the portfolio rebalancing procedure and the Active Portfolio Index calculation procedure; and

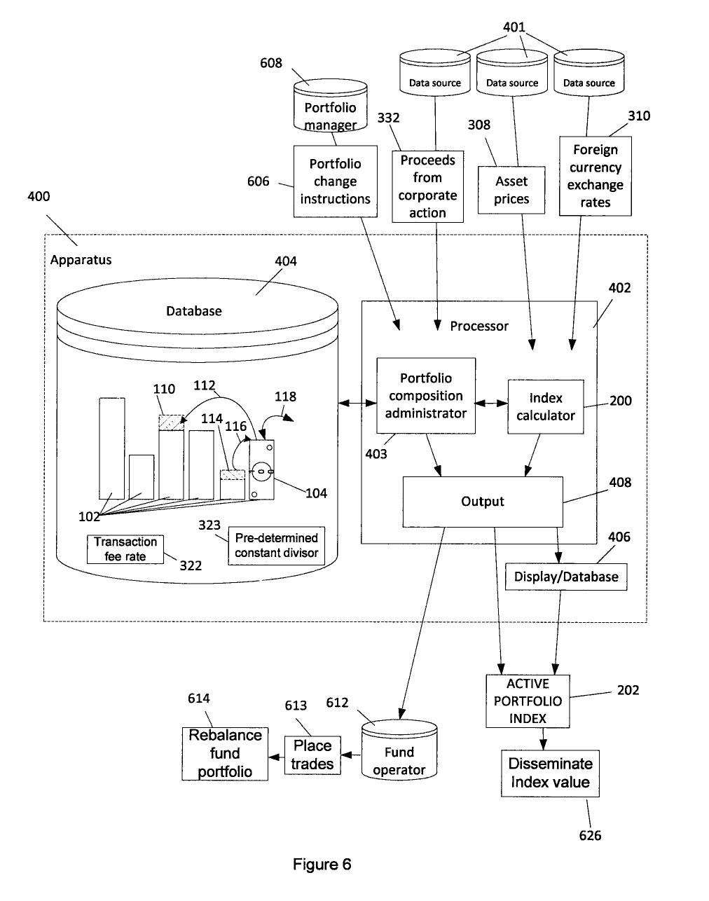

FIG. 6 shows the apparatus utilised to determine the Active Portfolio Index value.

### DETAILED DESCRIPTION

To allow Exchange-Traded Funds (ETFs) to be traded throughout the day, the fund must be highly transparent. A conventional way of achieving transparency is to base the fund on a stock market index (passive index ETF); in this case the fund is compositionally related to the index. It has been appreciated that an actively managed ETF however faces problems maintaining a suitable level of transparency. For full transparency it is necessary to publish the current securities portfolio daily such that any dealer in the ETF is able to hedge it. It is also necessary to reflect—and correctly manage—transaction costs (because active management involves significantly higher levels of turnover than a passive stock market index and because active managers compensate brokers for research services via commissions) and to include cash in an index (to control turnover). A suitable level of transparency must be provided thereby allowing dealers to hedge positions in the ETF and make markets in the ETF. These problems are solved with an index to an actively managed portfolio (an ‘Active Portfolio Index’).

The Active Portfolio Index is generated based on the composition of the portfolio. The Active Portfolio Index and the associated portfolio can be used as an underlier to an ETF, or derivative instruments. The Active Portfolio Index includes a cash component. In a most fundamental example, the Active Portfolio Index is simply the current value of the assets in the portfolio, including the cash component. This allows the Active Portfolio Index to operate as a dynamic, closed system, and changes of the portfolio's value are directly reflected in the index. The Active Portfolio Index may be considered in two components, a cash position and a stock position. Additions to the stock position result in a reduction of the cash position, and removals from the stock position increase the cash position. Dividends from the stock position result in an increase of the cash position. Transactions require payment of a transaction fee, resulting in a reduction of the cash position. To provide values of the Active Portfolio Index that are more manageable, the value of the assets in the portfolio, including the cash position, may be presented not at the full value, but scaled by a (predetermined) divisor. Notably the divisor does not change over time, but remains constant for the Active Portfolio Index that it is applied to.

FIGS. 1 and 2 illustrate the Active Portfolio Index. The Active Portfolio Index is composed of a number of asset components 102 that are typically shares, but can be any type of financial asset including equity, bonds, and other traded securities (for example REITs, Convertible Bonds, Mortgage Bonds, or Treasury Bills) as well as futures contracts on bonds, stock market indices or commodities. The Active Portfolio Index also includes a cash component 104. The individual asset components 102 each have a market value 108 that changes as the market moves. The number of asset components may be increased by buying more components of an asset already held 110 or by buying components of an asset not previously held. Buying assets results in a decrease 112 of the cash component 104. Similarly, the number of asset components may be decreased by selling components of an asset already held 114. Selling assets results in an increase 116 of the cash component 104. The buy/sell transactions 120 themselves may incur a transaction charge, resulting in a decrease 118 of the cash component 104. Cash proceeds from the assets (such as dividends) result in an increase 118 of the cash component 104. All these factors are combined in the index calculator 200 to determine the Active Portfolio Index 202 that represents the portfolio.

Calculation of the Active Portfolio Index 202 is shown in more detail in FIG. 3. FIG. 3 illustrates the case where the asset components 102 are shares belonging to a variety of stock. The index calculation for other asset types is analogous. The market value of the share component of the portfolio 300 is calculated by combining the contributions from each different stock 304 held. The contribution from each stock 304 is calculated by multiplying the number of shares 306 by the share price 308 and then converting the currency of those shares into the portfolio currency with the foreign currency exchange rate 310. The cash component 302 is calculated by subtraction of purchases, addition of sales, subtraction of transaction fees, and addition of proceeds from corporate actions and dividends, for each different stock held. The contribution from purchase or sale of shares 312 is calculated by multiplying the number of shares sold or bought 314 by the buy or sell price 316, and then converting the currency of those shares into the portfolio currency with the foreign currency exchange rate 318. The transaction fee for each purchase or sale of shares 320 is calculated by multiplying the number of shares sold or bought 314, by the buy or sell price 316, converting the currency of those shares into the portfolio currency with the foreign currency exchange rate 318, and multiplying the resulting value by a transaction fee rate 322. The index calculator 200 sums up the market value of the share component of the portfolio 300 and the cash component 302, and divides the sum by a constant divisor 340.

The shares in the portfolio can be chosen according to the portfolio's investment objective. Notably the shares in the Active Portfolio Index are generally not a function of company shares outstanding, unlike a passive market index-based ETF. Instead they are driven by an underlying investment process. The Active Portfolio Index can be used with many different types of underlying investment process.

Conventional indices represent markets, or groups of market components, typically a capitalisation-weighted (or free float capitalisation-weighted) set of stocks. These conventional indices often have a fixed or variable number of components, and additions to the component set often requires removal of another stock. The composition of conventional indices is rule-driven and largely static, with a low turnover. For capitalisation-weighted indices, the market value of the constituents' shares is scaled by an adjustable divisor. This adjustable divisor ensures that changes in the market value of the index which are due to additions or deletions of stocks, or corporate actions such as rights issues and takeovers do not cause jumps in the index value.

The present index described above differs from conventional indices in particular with regards to four important features: the cash component; the constant index divisor; the application of transaction costs; and the index being independent to market capitalisation of stock held. An important feature of the index described herein is that the index can be replicated through a trading book, allowing dealers to fully replicate the index and therefore make markets in the ETF.

The Active Portfolio Index is calculated based on the (actively managed) portfolio composition. The portfolio composition is the underlier to a fund, in particular an ETF. The Active Portfolio Index characterises the fund (with a dynamic composition of assets) and allows a dealer to hedge positions in instruments such as ETFs based on the index. This is an advantage of the ETF compared to other funds (such as open end mutual funds and closed end funds). The inclusion of the cash component in the portfolio reduces the costs of turnover in the portfolio that active management requires. In a portfolio with exclusively stock and no cash component, any purchase of new stock would require releasing a portion of every held stock to fit in the new stock. This would likely be quite unfavourable and result in excessive turnover and therefore slippage. Further, the inclusion of the cash component in the portfolio enables provision for transaction fees and dividends on stocks. Transaction fees facilitate the realistic reflection of the acquisition of new stock and release of held stock. A typical passive market index has low turnover and does not include transaction fees, and therefore is not suitable to an active management strategy. Payment of transaction fees in the form of a commission to brokers encourages provision of broker services, including execution services and research services. These factors benefit efficient management. The Active Portfolio Index is composed of a number of asset components and a cash component. The index calculation for the case where the asset components are shares belonging to a variety of stock is described in more detail below. The index calculation for other asset types is analogous.

Two main components are included in the portfolio: a stock; and a cash component. The market value of the portfolio is the sum of the market value of the stock constituents and cash. The Portfolio Market Value (PMV) at time t is:

PMV^{t}=SMVₜ+Cₜ

where SMVₜ is the market value of the stock component of the portfolio and Cₜ is the cash component of the portfolio.

$${IL}_{t} = \frac{{PMV}_{t}}{Divisor}$$

where the divisor is a constant.

The inclusion of cash in the Active Portfolio Index allows for a constant divisor. A passive market index would typically have a variable divisor, thereby allowing the index to add or subtract new components without impacting the index level (i.e. the divisor is changed to prevent an impact to the index level if a composition change is made).

### Calculation of the Market Value of the Stock Component

For a portfolio that is rebalanced once a day, the stock component of the portfolio only has one composition on each day. Changes occur after the close of business (COB) on each day. In practice, although changes occur after close of business, a dealer replicating the Active Portfolio Index would need to execute trades at the closing price that day to ensure that they had the correct positions at the following day's open of business (OOB). At the close of business of day t the market value of the stock component of the portfolio (SMV) is calculated:

$${SMV}_{t} = {\sum }_{i = 1}^{{N}_{t}} {P}_{i , t} \times {FX}_{i , t} \times {NS}_{i , t}$$

where:
P_{i,t} is the close of business price of stock ion day t;
FX_{i,t} is the foreign currency exchange rate on day t of the stock i currency to the portfolio currency;
NS_{i,t} is the number of shares of stock i held on day t; and
Nₜ is the total number of stock constituents included in the stock component of the portfolio before and at the close of business of day t.

### Calculation of the Cash Position (C)

The cash component of the portfolio changes as a result of: 1) transaction costs incurred, as a result of rebalancing changes to the portfolio, at the close; 2) rebalancing changes to the composition of the stock component of the portfolio, after the close; 3) corporate actions, before the open. The timing of each of these three components to the cash movement is important in ensuring that the Active Portfolio Index is replicable by dealers seeking to hedge instruments such as ETFs. Specifically, the cash position at close of business on day t is given by:
(1) Implies

Cₜ=Cₜ^{before}^{_{—}}^{open}−Fₜ
(2) and (3) together imply

Cₜ^{before}^{_{—}}^{open}=Cₜ₋₁+cpcorpacₜ−BuyValₜ₋₁+SellValₜ₋₁

where:
Cₜ is the cash position at close of business on day t;
Cₜ^{before}^{_{—}}^{open} is the cash position before open of business on day t;
Fₜ is the total of the transaction fees incurred on day t for subsequent rebalancing of the portfolio;
Cₜ₋₁ is the cash position at close of business of the previous day t−1;
cpcorpacₜ is the total amount of cash proceeds from corporate action and dividends, in the portfolio currency, received before the open on day t; and
BuyValₜ₋₁ and SellValₜ₋₁ are buy and sell values from rebalancing the share component held in the portfolio after the business close of the day t−1.

To keep the calculations simple, no interest is credited for the cash position. It is however possible to include interest on the cash position for calculating the index. In this case, the cash position has an additional contribution from an interest component that is related to the cash position and an interest rate.

The cash position may be determined on the basis of the actual cash balance, or the accrued cash balance. For simplicity, and following standard market practice, the index is based on the accrued cash balance—therefore all of transaction costs, buy and sell values, and corporate actions are dealt with on this basis.

Buy transactions reduce the cash position and add to stock position. The cash position is reduced by the closing price plus the transaction fee. Sell transactions increase the cash position and reduce the stock position. The cash position is increased by the closing price minus the transaction fee. The buy and sell values from rebalancing the share component are calculated with:

$${BuyVal}_{t} = {\sum }_{i = 1}^{{N}_{t}} {P}_{i , t} \times {FX}_{i , t} \times {NS}_{i , t}^{Δ} if {NS}_{i , t + 1} - {NS}_{i , t} > 0$$

$${SellVal}_{t} = {\sum }_{i = 1}^{{N}_{t}} {P}_{i , t} \times {FX}_{i , t} \times {NS}_{i , t}^{Δ} if {NS}_{i , t + 1} - {NS}_{i , t} < 0 ,$$

with NS_{i,t}^{Δ}=absoluteValue[NS_{i,t-1}−NS_{i,t}].

NS_{i,t}^{Δ} is the absolute value of the rebalancing adjustment to the number of shares of stock i held in the portfolio after the business close of the day t.

Transaction fees are considered in the Active Portfolio Index calculation. These transaction fees occur when trading stocks, and reflect commissions paid to dealers both for transaction services and for research services. Both buy and sell trades incur transaction fees. No allowance is made for UK Stamp Tax. Transaction fees are charged at the close of business. They are charged for subsequent portfolio rebalancing which takes place after the close on the same day. No transaction fees are charged on the first day of the index calculation.

The daily overall transaction fee Fₜ on day t is calculated as follows. For each stock component i the transaction fee F_{i,t} in that stock is:

F_{i,t}=Transaction Fee Rate×P_{i,t}×FX_{i,t}×NS_{i,t}^{Δ}

where Transaction Fee Rate is for example a rate of 6 basis points.

The total transaction fee on day t is:

$${F}_{t} = {\sum }_{i = 1}^{{N}_{t}^{Δ}} {F}_{i , t}$$

where Nᵢ^{Δ} is the total number of stock components being rebalanced on day t.

The index value is calculated at the close of business of day t, and is calculated as:

$${IL}_{t} = \frac{{SMV}_{t} + {C}_{t - 1} + {cpcorpac}_{t} - {BuyVal}_{t - 1} + {SellVal}_{t - 1} - {F}_{t}}{Divisor} .$$

Further to the calculation of the Active Portfolio Index as described in detail above, FIG. 4 illustrates an example of timing and contribution of different factors to the portfolio 350 comprising a stock component 346 (in units of shares) and a cash component 348 (in currency units). On the time axis 351 periods of business closure 352 alternate with periods of business 354 which are typically the length of a single working day. The stock composition of the portfolio has a composition that remains the same during each period of business, but the composition varies between periods of business. Taking now each new period of business to be a new working day, on day t the stock component i has a number of shares NS_{i,t} 356; on the next day t+1 the stock component has a number of shares NS_{i,t+1} 358. In the example illustrated in FIG. 4, the number of shares is increased by +NS^{Δ}_{i,t} 360. The conflicting requirements of maintaining the composition constant throughout the day, but having a different composition on the next day, are resolved by trading at the close of business (COB) 364 for the next day (note dealers trade in the closing auction to hedge this). For trades executed on day t, the transaction fees 366 are taken from the cash component on day t. This takes into account the reality of having to commit cash for the transaction at the time when the transaction is executed, immediately before close of business. The buy/sell value 368 is adjusted to the cash component in the next period, as the new stock composition takes effect in the next period. The final contribution to the cash component is cash proceeds from corporate action. These are added to the cash composition before open of business on the following day. For day t, the cash proceeds 370 from the preceding day t−1 are added to the cash component before the open on day t.

The index value 372 is calculated periodically, in this example daily at the close of business of for example day t. Changes to the stock market value 374 of the assets can cause an increase, or decrease, to the index value. As discussed above, transaction fees 366 are taken from the cash at the close of business (and index calculation in this example). Transaction fees reduce the index value. Cash proceeds from corporate action 370 from the preceding day t−1 are added to the cash component before the open on day t. Cash proceeds increase the index value. As discussed above, rebalancing occurs after close of business. Preferably, rebalancing is considered as re-allocation of assets within the portfolio, for instance from the cash component into the stock component for a purchase of shares. Preferably, the act of rebalancing does not change the index value at the time of rebalancing (bar transaction fees, which do decrease the index), as assets are simply transferred from the cash component into the stock component, or vice versa. As time progresses the rebalanced portfolio changes according to changes in the stock market value of the new composition.

In general, a cash balance averaging a particular percentage of the total portfolio value is maintained over time. The cash balance level is usefully calibrated against turnover of the portfolio. Greater turnover requires a higher cash balance on average to avoid the risk of going overdrawn. For example, the cash balance is expected to average 3-5% of portfolio value. By targeting an invested level of 97% of portfolio value the cash balance may be expected to be positive each day. This target level may be varied in periods of high market volatility. In exceptional cases, the cash component can be overdrawn for short periods and therefore a negative cash balance is technically possible, if not favourable. It is preferable to instate measures that prevent transactions that are likely to take the cash component into a negative cash balance. If the cash balance does become overdrawn (because, for example, of price changes that were not anticipated between announcements of daily portfolio composition changes and close of business) then on the next rebalance action can be enforced to restore a positive cash balance. If no such actions are taken, then for example all holdings may be proportionately reduced until a positive cash balance of a given level is restored at the first available opportunity. Other restrictions may be imposed on the trading activities, for instance it may not be permitted to sell short. In this case transactions that would cause selling short would be cancelled.

An alternative application of the Active Portfolio Index to a hedge fund would allow the cash balance to become overdrawn, and would allow short (or negative) positions in stocks as well as positive positions. The present characterisation of the Active Portfolio Index is for use as a “long-only” portfolio. However relaxing these two constraints (allowing overdrawn or negative cash and allowing short or negative stock positions) allows the index to serve equally well for hedge fund portfolios.

In one example, the initial notional value of the portfolio is EUR 100,000,000 and the divisor is 100,000, giving an initial Active Portfolio Index level of 1000. In this example the divisor is fixed at 100,000. For a cash quota of 3% of the portfolio value the cash position is maintained around EUR 3,000,000.

The Active Portfolio Index is rebalanced on a daily basis, with rebalancing occurring after the close of each index calculation day. On each index calculation day, a daily index changes file is transmitted to an index calculation agent for example at 1 pm with the names where there is trading activity. The daily index changes file may for instance contain information in XML format. An example of the fields specified is:
SNAPSHOT_UID An identifier unique for each data submission, used for reference.
BB_COMPOSITE_TICKER Bloomberg ticker for composite exchange, used for reference.
SEDOL_Used for security identification
ISIN_Used for security identification
SECURITY_NAME
DAY_OPEN_SHARES
TRADE_SHARES Positive number for buy, negative number for sell
NEW_SHARES
PRICE_LCCY_YES 12: price as determined by GLG in local currency
LOCAL_CCY 3 character currency code (“EUR”, “CHF”, “SEK” etc.)
PRICE_EUR 12:00 price as determined in EUR
COMMENT Text comment

Any strategy of stock selection criteria may be applied to the portfolio. Regarding the composition of the stock position of the portfolio, cap factors may be applied based on the number of components. For example:
20% cap factor if the number of components is less than 25;
15% cap factor if the number of components is between 25 and 39;
10% cap factor if the number of components is 40 or more.

The portfolio may for example be constructed to be market cap neutral versus a broad market index. Position adjustments may be based on algorithms designed to maximise the returns from a given strategy. Broker investment ideas may provide the investment universe for the portfolio. Algorithms may be used to construct the portfolio, for example for portfolio optimisation. Eligible stocks may be restricted to a selection of countries of domicile.

In one example, eligible stocks are restricted as follows. Three criteria are taken into account in determining domicile:
1. place of incorporation of the company,
2. place of headquarters of the company,
3. place of taxation of the company.

Eligible countries are:

| | | | Market |
|---|---|---|---|
| No. | Country | Default Exchange | Identification Code |
| 1 | UK | London Stock Exchange | XLON |
| 2 | Finland | Helsinki Stock Exchange | XHEL |
| 3 | Sweden | Om Stockholm Exchange | XSTO |
| 4 | Norway | Oslo Stock Exchange | XOSL |
| 5 | Denmark | Copenhagen Stock Exchange | XCSE |
| 6 | Netherlands | Euronext Amsterdam | XAMS |
| 7 | Belgium | Euronext Brussels | XBRU |
| 8 | Luxembourg | Luxembourg Stock Exchange | XLUX |
| 9 | Germany | XETRA | XETR |
| 10 | France | Euronext Paris | XPAR |
| 11 | Switzerland | SIX Swiss Exchange* | XSWX |
| 12 | Austria | Vienna Stock Exchange | WBAH |
| 13 | Italy | Borsa Italiana | MTAA |
| 14 | Spain | Spanish Continuous Market | XMCE |
| 15 | Portugal | Euronext Lisbon | XLIS |
| 16 | Ireland | Irish Stock Exchange | XDUB |
| 17 | Greece | Athens Stock Exchange | XATH |

*Note that SIX Swiss Exchange includes SWX Europe. Swiss stocks currently trade on only one of SIX Swiss Exchange and SWX Europe. Therefore the closing price from the relevant exchange is used in every case.

Foreign exchange rates are taken from published data, for example by WM Reuters. The exchange rates can be used with the US Dollar, with cross rates calculated from these rates.

Continuing the example of a selection of countries of domicile, dividends may be subject to withholding tax rates. The cash return on dividends is decreased depending on the country of domicile:

| No. | Country | Withholding Tax Rate |
|---|---|---|
| 1 | UK | 0% |
| 2 | Finland | 28% |
| 3 | Sweden | 30% |
| 4 | Norway | 25% |
| 5 | Denmark | 28% |
| 6 | Netherlands | 15% |
| 7 | Belgium | 25% |
| 8 | Luxembourg | 15% |
| 9 | Germany | 26.375% |
| 10 | France | 25% |
| 11 | Switzerland | 35% |
| 12 | Austria | 25% |
| 13 | Italy | 27% |
| 14 | Spain | 19% |
| 15 | Portugal | 20% |
| 16 | Ireland | 20% |
| 17 | Greece | 10% |

Regarding corporate actions that relate to the stocks in the portfolio, the response may be chosen depending on the portfolio investment strategy. Corporate actions may be monitored on a daily basis. A set of rules may be defined for treatment of specific corporate actions, for example:

| Corporate Action | Treatment |
|---|---|
| Dividends | Credit as cash on ex-date at gross dividend less |
| | withholding tax as detailed above. |
| Optional | Cash is the selected option. |
| dividends | |
| Special | As per cash dividends. |
| dividends | |
| Change in shares | No response (this is substantially different |
| outstanding | to the treatment in conventional indices). |
| Stock split | Shares in index adjusted. No further adjustments. |
| Spin-off | Both existing and spin-off stocks retained if |
| | stocks are in eligible countries. No further |
| | adjustment required. If either stock is in |
| | an ineligible country, then execute sell |
| | transaction in that stock. |
| Rights offering | Assume full exercise of rights issue on ex-rights |
| | day if rights are trading in-the-money. |
| | Debit cash balance for cost of exercising |
| | rights as determined by subscription |
| | price and terms of rights offering. |
| | Increase number of shares to reflect new |
| | holding. Where a choice exists |
| | always assume full take up of rights. |
| | If insufficient cash exists to exercise rights then |
| | exercise none, and delay until first day when |
| | sufficient cash exists to exercise rights. |
| | If rights are trading at- or out-of-the-money |
| | then exercise none, and delay until first day when |
| | rights are trading in-the-money. |
| | This treatment is substantially different to the |
| | treatment in conventional equity indices. |
| Takeovers | Take cash option if exists. If not, |
| | take stock option, and if stock ineligible |
| | then execute sell transaction in that stock. |

In the following section, the details of an example calculation and publication of the Active Portfolio Index are described. For publication of the index, at the open of each index calculation day, the index calculation agent transmits to a source, or the fund manager, or to selected brokers a daily open composition file with all stocks in portfolio including a cash field, using for example the format below or the index calculation agent's preferred format (suggested XML format) with the following specified fields:

| No. | Item |
|---|---|
| 1 | Bloomberg ID |
| 2 | Sedol |
| 3 | ISIN |
| 4 | Company Name |
| 5 | Day open position (shares) |
| 6 | Current price (LCL) [note for information only] |
| 7 | Current price (EUR) [note for information only] |
| 8 | Index weight |
| 9 | Comment [for information only] |

The index calculation agent verifies each day that changes to the portfolio are in stocks in eligible countries and that no stock is expected to exceed, for example, 5% weight in the portfolio. The index calculation agent further verifies that changes to the portfolio are not expected to result in a negative cash situation. The index calculation agent can use for the calculation either:
the previous day closing price, or
the latest available intra-day price.

FIG. 5 and the following table illustrate an example of the portfolio rebalancing procedure 600 and the Active Portfolio Index determining (calculating) procedure 616. In this example, the index calculation agent 601 schedules daily index calculation and portfolio rebalancing:

| Time | Event |
|---|---|
| 13:00 hrs | The active portfolio manager 608 transmits |
| | daily Active Portfolio Index changes 606 |
| | to the index calculation agent 604. |
| | If the manager is not ready at 13:00, then |
| | the index calculation agent 601 polls |
| | for a posting at 10 minute intervals until 14:00. |
| | If no posting by 14:00 then the index |
| | calculation agent assumes no changes for the day. |
| 13:00 to 14:00 hrs | The index calculation agent 601 verifies |
| | portfolio changes 610 for valid |
| | securities and positive cash balance. |
| | If the index calculation agent |
| | detects rules violation, then the |
| | index calculation agent contacts the active |
| | portfolio manager for instructions. |
| | If the index calculation agent is unable to contact |
| | the manager, and the portfolio would be |
| | overdrawn by the index calculation agent's internal |
| | estimation, then the index calculation agent |
| | reduces the portfolio exposure as described above. |
| 14:00 hrs | The index calculation agent 601 transmits |
| | portfolio composition changes 615 |
| | to selected brokers (or in general fund |
| | operators 612). If the index calculation |
| | is delayed, then the index calculation agent |
| | may post changes at any time prior to 15:00 hrs. |
| 17:30-18:00 hrs | The index calculation agent 601 may |
| | disseminate: the composition of the portfolio |
| | after close at t; the expected composition |
| | at t + 1 open; and/or the index value 626. |

Selected brokers (or in general fund operators 612) that have received portfolio composition change information 615 are then able to place trades 613 in order to rebalance their fund portfolio 614 in preparation for the next business day. As discussed above, trades are placed at the close of business (market closing auction) (COB) so that the next day's portfolio reflects the changes. The fund portfolio 614 is rebalanced shortly after close of business.

In the case of holidays, the active portfolio manager does not make changes to the portfolio in any stock where the exchange on which the stock is listed is not open for a complete trading day. Similarly the index calculation agent does not accept changes to the Active Portfolio Index in any stock where the exchange on which the stock is listed is not open for a complete trading day

The Active Portfolio Index is calculated and published by the index calculation agent on any trading day, to be defined as a day where the default exchange of at least one of the index constituents is open. The Active Portfolio Index may be published less frequently than daily, for example every other day, weekly, or fortnightly. The Active Portfolio Index may also be published more frequently than once per day, for example twice per day, three times per day, or hourly. More frequent publications could increase the volatility of shares on the fund, and may discourage using the ETF for hedging.

As regards calculation, the composition of the Active Portfolio Index (and the portfolio) remains static between calculation periods. The execution of trades may take place at the end of the trading day, requiring a fairly liquid strategy. Transactions may be placed with brokers who execute the transactions. For calculation the trades are considered to be executed at the end of the day, as defined in the equations above.

In the example illustrated in FIG. 5, the index calculation agent 601 administrates the Active Portfolio Index (and portfolio). For this purpose, information 605 is received from external data sources 603 regarding cash proceeds (for instance dividends and/or interest). This information is used to update the cash component of the portfolio 602. As described above, proceeds from corporate actions are added to the cash component.

In addition to the actions the index calculation agent takes as discussed above, the index calculation agent 601 calculates the value of the Active Portfolio Index 624. For this purpose, information 607 is received from external data sources 609 regarding the market value of the current portfolio (for instance share prices, and/or foreign currency exchange rates).

The value of the Active Portfolio Index is calculated with an index calculator. The index calculator may be implemented as a computer program that operates on a computer that has been modified to execute that computer program and function as an index calculator. The computer program can be constructed in VBA with Excel, or C# and MatLab, for example. Alternative means of constructing and implementing a suitable index calculator will be evident.

As shown in FIG. 6, an apparatus is provided to determine the index value. The apparatus 400 comprises a processor 402, a database 404, and a display/database or the like 406. The processor 402 is adapted to receive data from external data sources 401.

One part of the processor is the portfolio composition administrator 403. The portfolio composition administrator 403 administrates the Active Portfolio Index (and portfolio) composition. For this purpose data from external data sources 401 is used, for example the portfolio change instructions 606 from the portfolio manager 608 or the like. The portfolio composition administrator 403 may also verify if the portfolio change instructions 606 are permitted. For example, the portfolio change instructions 606 may be verified for valid securities and positive cash balance. If a rules violation is detected, then the active portfolio manager may be contacted. Portfolio change instructions 606 that are not permitted may be rejected. The portfolio composition administrator 403 exchanges data with the index calculator 200, as described below. Further external data may be used to administrate the portfolio composition, for example current share value 308; foreign currency exchange rates 310; information regarding proceeds such as dividends 332; transaction fee rates; or buy or sell price of executed transactions. The portfolio composition administrator 403 may actively initiate data retrieval to the processor 402, or it may passively receive data that has been transmitted to the processor 402.

Another part of the processor is the index calculator 200. The index calculator 200 calculates the index value. For this purpose data from external data sources 401 is used, for example the asset prices 308 and foreign currency exchange rates 310 or data relating for example to the market value of the assets. The index composition information is retrieved from the database 404, under certain circumstances via the portfolio composition administrator 403.

The processor is further adapted to output data relating to the index value (as described above), which is output to a display/database; for example, the display could be used to trade the ETF, and/or information relating to the index can be stored in an additional database.

The database 404 stores data relating to the current asset portfolio. The data relating to the current asset portfolio includes for example the number of shares currently in the portfolio for a particular stock, and the number of shares to be bought or sold. Further data may be stored in the database 404, for example: current share value 308; foreign currency exchange rates 310; information regarding proceeds such as dividends 332; transaction fee rates 322; buy or sell price of executed transactions; and/or the predetermined constant divisor 323 of the Active Portfolio Index. The data may also be stored in another database or databases.

Real-time data such as share value may be constantly streamed to the apparatus. In this case the database 402, or another database(s), may act as buffer(s), for instance by storing only the current share value, or by storing only certain values, for example the daily close of business value. Alternatively, the apparatus may access and retrieve the external information from an external database. A suitable protocol for transferring the external data is for example HTTP, FTP, or TDS. The external data may be supplied by a commercial data supplier. The data relating to the current asset portfolio, and data relating to planned changes to the asset portfolio, can be transmitted to the index calculator in file format, for example XML as described above. Alternatively another form of input can be used to transmit changes to the current portfolio, for instance with a graphic user interface, mouse, and/or keyboard. Other means of input will be evident.

As described above, a special purpose computer, or system of computers, is constructed to generate the Active Portfolio Index. The system draws upon tangible, real-time data from a multitude of sources. The data is manipulated by a specially programmed computer to produce the Active Portfolio Index. The computer may be adapted to generate the Active Portfolio Index by executing a computer program product embedded on a machine readable storage medium such as a hard disk, a CD-ROM, or an external memory device. A non-transitory computer-readable medium encodes a data structure that calculates and stores the Active Portfolio Index.

It will be understood that the present invention has been described above purely by way of example, and modifications of detail can be made within the scope of the invention.

Each feature disclosed in the description, and (where appropriate) the claims and drawings may be provided independently or in any appropriate combination.

1. A method of generating an index for a portfolio, comprising determining the index value of the portfolio in dependence on the value of the assets comprising the portfolio, wherein said assets include cash.

2. A method according to claim 1, wherein the index is suitable for use as an underlier to at least one of: a fund; a stock market fund; a traded fund; an exchange traded fund; an active exchange traded fund; and a derivative instrument.

3. A method according to claim 1, wherein assets being added to the portfolio are balanced in the index by subtracting the associated purchase value from the cash.

4. A method according to claim 1, wherein assets being released from the portfolio are balanced in the index by adding the associated sale value to the cash.

5. A method according to claim 1, wherein a transaction fee is subtracted from the cash for at least one of: purchase of assets; and sale of assets.

6. A method according to claim 1, wherein proceeds from said assets are added to the cash.

7. A method according claim 6, wherein the proceeds are at least one of: dividends;
bonuses; coupon payments; and interest.

8. A method according to claim 1, further comprising rebalancing the portfolio.

9. A method according to claim 8, wherein the portfolio is periodically rebalanced.

10. A method according to claim 8, wherein the portfolio is rebalanced at substantially the same time as (preferably shortly after) said index value of the portfolio is determined.

11. A method according to claim 9, wherein said index value of the portfolio at a given period is dependent upon the current value of a stock component of the portfolio and cash expended in changing the composition of the portfolio for the preceding rebalancing.

12. A method according to claim 8, wherein said index value of the portfolio is dependent upon a fee, said fee being associated with a change in the composition of assets to be made at the next rebalancing.

13. A method according to claim 8, wherein said portfolio rebalancing comprises:
a) receiving instructions to change said portfolio;
b) verifying that the changes to said portfolio are permitted; and
c) transmitting said instructions.

14. A method according to claim 1, wherein said index value of the portfolio is determined periodically.

15. A method according to claim 14, wherein said index value of the portfolio is determined more frequently than hourly and less frequently than weekly.

16. A method according to claim 15, wherein said index value of the portfolio is determined at close of business.

17. A method according to claim 1, wherein a composition of the portfolio does not change in the period from open of business to close of business.

18. A method according to claim 1, wherein the cash comprises between 0.5% and 15% of the portfolio value.

19. A method according to claim 18, wherein the cash comprises between 3% and 5% of the portfolio value.

20. A method according to claim 1, wherein the value of each asset type in the portfolio is limited to a predetermined maximum percentage of the fund portfolio.

21. A method according to claim 20, wherein the maximum percentage of the portfolio value depends on the number of asset types in the portfolio.

22. A method according to claim 21, wherein the value of each asset type is limited to 20% of the portfolio value when there are less than 25 asset types; the value of each asset type is limited to 15% of the portfolio value when there are between 25 and 39 asset types; and the value of each asset type is limited to 10% of the portfolio value when there are more than 40 asset types.

23. A method according to claim 1, wherein the index is calculated by dividing the value of the assets comprising the portfolio by a predetermined constant number.

24. A method of generating an index for a portfolio, comprising determining the index value of the portfolio in dependence on the value of the assets comprising the portfolio, wherein the value of the assets comprising the portfolio is divided by a predetermined constant number.

25. Apparatus for generating an index for a portfolio, comprising: a processor adapted to determine the index value of the portfolio in dependence on the value of the assets comprising the portfolio, wherein said assets include cash, and an output adapted to output the index value.

26. Apparatus according to claim 25, wherein the index is suitable for use as an underlier to at least one of: a fund; a stock market fund; an exchange traded fund; an active exchange traded fund; and a derivative instrument.

27. Apparatus according to claim 25, wherein the processor is adapted to divide the value of the assets comprising the portfolio by a predetermined constant number.

28. Apparatus for generating an index for portfolio, comprising: a processor adapted to determine the index value of the portfolio in dependence on the value of the assets comprising the portfolio, wherein the value of the assets comprising the portfolio is divided by a predetermined constant number; and an output adapted to output the index value.

29. Apparatus for generating an index for a portfolio, comprising: means for determining the index value of the portfolio in dependence on the value of the assets comprising the portfolio, wherein said assets include cash, and means for outputting said index value.

30. A non-transitory computer-readable medium encoding a data structure for generating an index for a portfolio, said data structure being adapted to determine the index value of the portfolio in dependence on the value of the assets comprising the portfolio, wherein said assets include cash.

31. A non-transitory computer-readable medium according to claim 30, wherein the index is suitable for use as an underlier to at least one of: a fund; a stock market fund; an exchange traded fund; an active exchange traded fund; and a derivative instrument.

32. A non-transitory computer-readable medium according to claim 30, wherein the index is determined by using said data structure to access the stored value of the assets comprising the portfolio and by dividing the value by a predetermined constant number.

33. An index for a portfolio, wherein the index value of the portfolio is determined in dependence on the value of the assets comprising the portfolio, and wherein said assets include cash.

34. An index for an actively managed portfolio suitable for use as an underlier to an exchange traded fund.
